(19) United States
(12) Patent Application Publication
(10) Pub. No.: US 2021/0064669 A1
(43) Pub. Date: Mar. 4, 2021

(54) SYSTEMS AND METHODS FOR DETERMINING CORRELATIVE POINTS OF INTEREST ASSOCIATED WITH AN ADDRESS QUERY

(71) Applicant: BEIJING DIDI INFINITY TECHNOLOGY AND DEVELOPMENT CO., LTD., Beijing (CN)

(72) Inventors: Juan HU, Beijing (CN); Huan CHEN, Beijing (CN); Qi SONG, Beijing (CN); Li MA, Beijing (CN)

(73) Assignee: BEIJING DIDI INFINITY TECHNOLOGY AND DEVELOPMENT CO., LTD., Beijing (CN)

(21) Appl. No.: 17/096,959

(22) Filed: Nov. 13, 2020

Related U.S. Application Data
(63) Continuation of application No. PCT/CN2018/125994, filed on Dec. 31, 2018.

(30) Foreign Application Priority Data
Dec. 29, 2018 (CN) 201811642784.2

(51) Int. Cl. G06F 16/9032; G06F 16/9035; G06F 16/9038; G06F 16/909; G06F 9/54

(52) U.S. Cl. CPC G06F 16/90332; G06F 16/9035; G06F 9/542; G06F 16/909; G06F 16/9038

(57) ABSTRACT

The present disclosure relates to systems and methods for determining points of interest. The methods may include obtaining a target address query associated with a service request from a user terminal; determining a plurality of initial terms based on the target address query; determining a plurality of term weights based on the plurality of initial terms, respectively; determining one or more candidate points of interest (POIs) based on the plurality of term weights according to an iterative process; determining one or more target POIs based on the one or more candidate POIs; and transmitting the one or more target POIs to the user terminal.

### CROSS-REFERENCE TO RELATED APPLICATIONS

This application a Continuation of International Application No. PCT/CN2018/125994, filed on Dec. 31, 2018, which claims priority of Chinese Patent Application No. 201811642784.2, filed on Dec. 29, 2018, the entire contents of each of which are hereby incorporated by reference.

### TECHNICAL FIELD

The present disclosure generally relates to systems and methods for online to offline services, and in particular, to systems and methods for determining correlative points of interest associated with an address query.

### BACKGROUND

Online to offline services utilizing Internet technology have become increasingly popular. In some cases, a user may input an address query (e.g., an address query associated with a destination) via a user terminal when the user needs to initiate a service request (e.g., a request for taxi hailing services). After receiving the address query, a system providing online to offline services can determine one or more correlative points of interest (POIs) associated with the address query based on predetermined rules and recommend the one or more correlative POIs to the user terminal. The user may select a POI from the one or more correlative POIs as a service location (e.g., a start location, a destination) and then send the service request via the user terminal. However, in some situations, the address query may include incorrect or redundant information (e.g., error/redundant input from the user). The redundant information in the address query may cause a wrong correlation between the POIs the system determined and the address query, or lead to no POI. Therefore, it is desirable to provide systems and methods for determining correlative POIs associated with an address query, in which the redundant information may be omitted from the address query and a correct correlation between the POIs determined and the address query may be obtained.

### SUMMARY

According to an aspect of the present disclosure, a system for determining points of interest may include at least one storage device and at least one processor adapted to communicate with the at least one storage device. The at least one storage device may include a set of executable instructions. When executing the set of executable instructions, the at least one processor may be configured to cause the system to perform one or more of the following operations. The system may obtain a target address query associated with a service request from a user terminal. The system may determine a plurality of initial terms based on the target address query. The system may determine a plurality of term weights based on the plurality of initial terms, respectively. The system may determine one or more candidate points of interest (POIs) based on the plurality of term weights according to an iterative process. The iterative process may include one or more iterations, and the iterative process may be terminated when one or more POIs retrieved in an iteration of the one or more iterations satisfy a preset condition. The system may determine one or more target POIs based on the one or more candidate POIs. The system may transmit the one or more target POIs to the user terminal.

In some embodiments, the target address query may be a text query or a voice query.

In some embodiments, to determine the plurality of initial terms based on the target address query, the at least one processor may be configured to cause the system to determine whether there is at least one wrong term in the target address query; in response to a determination that there is at least one wrong term in the target address query, correct the target address query; and segment a corrected target address query into the plurality of initial terms.

In some embodiments, to determine the plurality of term weights based on the plurality of initial terms, respectively, the at least one processor may be further configured to cause the system to determine a term weight of the plurality of term weights for each of the plurality of initial terms by searching a pre-generated term table. The pre-generated term table may include a plurality of candidate terms and a plurality of corresponding candidate term weights.

In some embodiments, the pre-generated term table may be determined based on a term frequency-inverse document frequency algorithm.

In some embodiments, to determine the one or more candidate POIs based on the plurality of term weights according to the iterative process, the at least one processor may be further configured to cause the system to in each of the one or more iterations, select an initial term with a lowest term weight from one or more current terms included in the plurality of initial terms; determine one or more remaining terms based on the one or more current terms, the initial term, or one or more redundant terms determined in one or more prior iterations; perform a retrieve operation based on the one or more remaining terms; determine whether there is at least one POI retrieved; in response to a determination that there is at least one POI retrieved, determine whether the at least one retrieved POI satisfies the preset condition; and in response to a determination that the at least one retrieved POI satisfies the preset condition, determine the one or more candidate POIs based on the at least one retrieved POI.

In some embodiments, the at least one processor may be further configured to cause the system to in response to a determination that there is no POI retrieved, determine the initial term as a redundant term.

In some embodiments, the at least one processor may be further configured to cause the system to in response to a determination that the at least one retrieved POI dose not satisfy the preset condition, determine that the initial term is not a redundant term.

In some embodiments, the at least one processor may be further configured to cause the system to determine whether all the initial terms are selected; and in response to a determination that all the initial terms are selected, transmit a notification to the user terminal.

According to another aspect of the present disclosure, a method for determining points of interest is provided. The method may be implemented on a computing device. The computing device may include at least one processor, at least one storage device, and a communication platform connected to a network. The method may include one or more of the following operations. The at least one processor may determine a plurality of initial terms based on the target address query. The at least one processor may determine a plurality of term weights based on the plurality of initial terms, respectively. The at least one processor may determine one or more candidate points of interest (POIs) based on the plurality of term weights according to an iterative process. The iterative process may include one or more iterations, and the iterative process may be terminated when one or more POIs retrieved in an iteration of the one or more iterations satisfy a preset condition. The at least one processor may determine one or more target POIs based on the one or more candidate POIs. The at least one processor may transmit the one or more target POIs to the user terminal.

According to yet another aspect of the present disclosure, a non-transitory computer readable medium may comprise executable instructions for determining points of interest. The executable instructions may be executed by at least one processor of a computing device. The at least one processor may determine a plurality of initial terms based on the target address query. The at least one processor may determine a plurality of term weights based on the plurality of initial terms, respectively. The at least one processor may determine one or more candidate points of interest (POIs) based on the plurality of term weights according to an iterative process. The iterative process may include one or more iterations, and the iterative process may be terminated when one or more POIs retrieved in an iteration of the one or more iterations satisfy a preset condition. The at least one processor may determine one or more target POIs based on the one or more candidate POIs. The at least one processor may transmit the one or more target POIs to the user terminal.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing device according to some embodiments of the present disclosure;

FIG. 5 is a flowchart illustrating an exemplary process for determining one or more target POIs associated with a target address query according to some embodiments of the present disclosure; and

FIG. 6 is a flowchart illustrating an exemplary process for processing a target address query according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding a transportation service, it should also be understood that this is only one exemplary embodiment. The system or method of the present disclosure may be applied to any other kind of online to offline service. For example, the system or method of the present disclosure may be applied to transportation systems of different environments including land, ocean, aerospace, or the like, or any combination thereof. Those transportation systems may provide transportation services transporting a subject from one location to another location using a vehicle. The subject may include passengers and/or goods. The vehicle of the transportation service may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The transportation services may include a taxi hailing service, a chauffeur service, a delivery service, a carpooling service, a bus service, a take-out service, a driver hiring service, a shuttle service, or the like, or any combination thereof. The application scenarios of the system or method of the present disclosure may include a web page, a plug-in of a browser, a client terminal, a custom system, an internal analysis system, an artificial intelligence robot, or the like, or any combination thereof.

The terms “passenger,” “requester,” “requestor,” “service requester,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, terms “passenger” and “passenger terminal” may be used interchangeably, and terms “driver” and “driver terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for recommending one or more target points of interest (POIs) associated with a target address query to a user through a user terminal. The target address query may be inputted by the user as an intended service location (e.g., a start location, a destination) associated with a service request. In response to the target address query, the systems and methods may determine a plurality of initial terms and corresponding plurality of term weights. The systems and methods may then determine one or more candidate POIs based on the plurality of initial terms and the plurality of term weights according to an iterative process. During the iterative process, one or more initial terms of the plurality of initial terms that are determined as redundant terms may be omitted. The systems and methods may determine, based on omitting the redundant terms from the plurality of initial terms, the one or more candidate POIs by performing retrieve operations. The correlation values between the one or more candidate POIs and the target address query may be not less than a threshold. The systems and methods may further determine the one or more target POIs based on the one or more candidate POIs. The systems and methods may further transmit the one or more target POIs to the user terminal. In the present disclosure, by performing the operation of omitting the redundant terms from the plurality of initial terms, the results of no POI retrieved caused by the redundant terms may be resolved. Furthermore, the bad correlation between target POIs (or the candidate POIs) and the target address query caused by the redundant terms may be improved.

It should be noted that while queries for points of interest (POIs) are used as examples for the present disclosure, the optimization of other types of queries can also utilize the methods and systems herein disclosed. Instead of target POIs, target terms of interest (TOIs), as a general subject matter, can also be provided based on the query inputted by a user and historical data. The POIs and the scenario of transportation service are used as examples for the methods and systems herein disclosed, not as limitations. In addition, the queries or POIs or TOIs of the present disclosure may refer to complete or incomplete entries from a user.

It should be noted that online to offline services, such as the online transportation service, is a new form of service rooted only in post-Internet era. It provides technical solutions to users and service providers that could raise only in post-Internet era. In pre-Internet era, when a passenger hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online transportation service, however, allows a user of the service to real-time and automatically distribute a service request to a vast number of individual service providers (e.g., taxi drivers) distance away from the user. It also allows a plurality of service providers to respond to the service request simultaneously and in real-time. Therefore, through the Internet, the online on-demand transportation systems may provide a much more efficient transaction platform for the users and the service providers that may never meet in a traditional pre-Internet transportation service system.

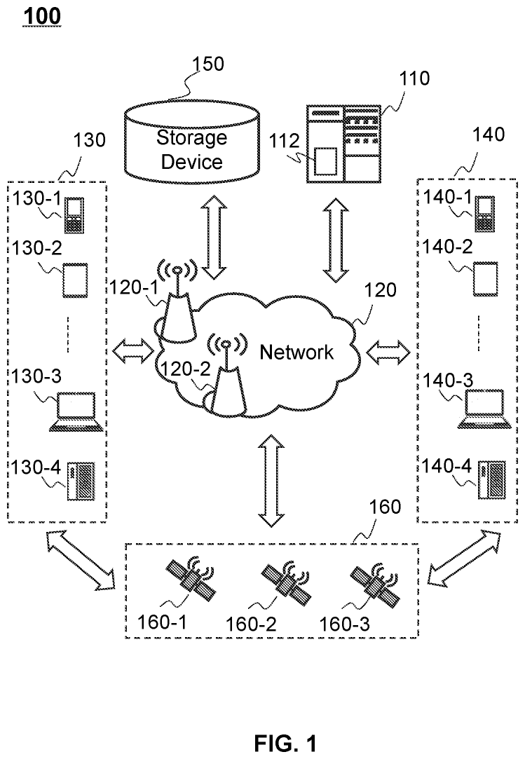

FIG. 1 is a schematic diagram illustrating an exemplary online to offline service system 100 according to some embodiments of the present disclosure. In some embodiments, the online to offline service system 100 may be a system for online to offline services. For example, the online to offline service system 100 may be an online transportation service platform for transportation services such as taxi hailing, chauffeur services, delivery vehicles, express car, carpool, bus service, driver hiring, and shuttle services. As illustrated in FIG. 1, the online to offline service system 100 may include a server 110, a network 120, a requester terminal 130, a provider terminal 140, a storage device 150, and a positioning system 160.

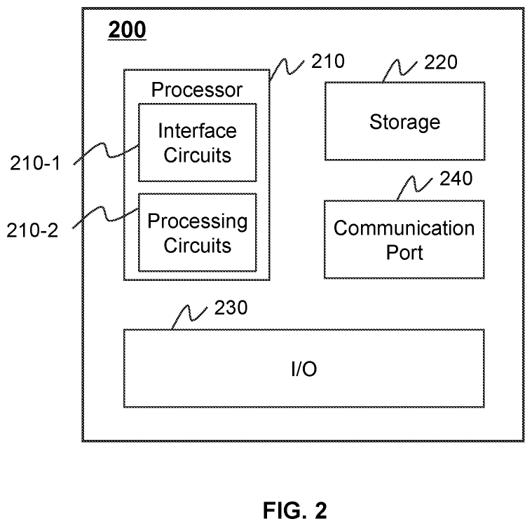

In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 150 via the network 120. As another example, the server 110 may be directly connected to the requester terminal 130, the provider terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. The processing device 112 may process information and/or data relating to the online to offline service. For example, the processing device 112 may determine one or more target POIs associated with a target address query according to an iterative process. In some embodiments, the processing device 112 may include one or more processing engines (e.g., single-core processing engine(s) or multi-core processor(s)). The processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the online to offline service system 100 (e.g., the server 110, the requester terminal 130, the provider terminal 140, or the storage device 150) may transmit information and/or data to other component(s) of the online to offline service system 100 via the network 120. For example, the server 110 may obtain a service request from the requester terminal 130 via the network 120. In some embodiments, the network 120 may be any type of wired or wireless network, or any combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public switched telephone network (PSTN), a Bluetooth™ network, a ZigBee™ network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online to offline service system 100 may be connected to the network 120 to exchange data and/or information.

In some embodiments, a requester may be a user of the requester terminal 130. In some embodiments, the user of the requester terminal 130 may be someone other than the service requester. For example, a user A of the requester terminal 130 may use the requester terminal 130 to send a service request for a user B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a user D, and/or information or instructions from the server 110. In some embodiments, “service requester,” “requester,” and “requester terminal” may be used interchangeably, and “service provider,” “provider,” and “provider terminal” may be used interchangeably.

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, a built-in device in the vehicle 130-4 may include an onboard computer, an onboard television, etc. In some embodiments, the requester terminal 130 may be a device with positioning technology for locating the position of a user of the requester terminal 130 (e.g., a service requester) and/or the requester terminal 130.

In some embodiments, the provider terminal 140 may be a device similar to, or the same as the requester terminal 130. In some embodiments, the provider terminal 140 may be a device utilizing positioning technology for locating the position of a user of the provider terminal 140 (e.g., a service provider) and/or the provider terminal 140. In some embodiments, the requester terminal 130 and/or the provider terminal 140 may communicate with one or more other positioning devices to determine the position of the service requester, the requester terminal 130, the service provider, and/or the provider terminal 140. In some embodiments, the requester terminal 130 and/or the provider terminal 140 may send positioning information to the server 110.

The storage device 150 may store data and/or instructions. In some embodiments, the storage device 150 may store data obtained from the requester terminal 130 and/or the provider terminal 140. In some embodiments, the storage device 150 may store data and/or instructions that the server 110 may execute or use to perform exemplary methods described in the present disclosure. For example, the storage device 150 may store data and/or instructions that the server 110 may execute or use to determine one or more target POIs described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components of the online to offline service system 100 (e.g., the server 110, the requester terminal 130, the provider terminal 140, etc.). One or more components of the online to offline service system 100 may access the data and/or instructions stored in the storage device 150 via the network 120. In some embodiments, the storage device 150 may be directly connected to or communicate with one or more components of the online to offline service system 100 (e.g., the server 110, the requester terminal 130, the provider terminal 140, etc.). In some embodiments, one or more components of the online to offline service system 100 (e.g., the server 110, the requester terminal 130, the provider terminal 140, etc.) may have permission to access the storage device 150. In some embodiments, the storage 150 may be part of the server 110.

The positioning system 160 may determine information associated with an object, for example, the requester terminal 130, the provider terminal 140, etc. For example, the positioning system 160 may determine a current location of the requester terminal 130. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, the requester terminal 130, or the provider terminal 140 via wireless connections.

In some embodiments, information exchanging of one or more components of the online to offline service system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element (or component) of the online to offline service system 100 performs, the element may perform through electrical signals and/or electromagnetic signals. For example, when the requester terminal 130 transmits a service request to the server 110, a processor of the requester terminal 130 may generate an electrical signal encoding the service request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, the provider terminal 140 may process a task through operation of logic circuits in its processor, and receive an instruction and/or a service request from the server 110 via electrical signals or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium (e.g., the storage device 150), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device 200 according to some embodiments of the present disclosure. In some embodiments, the server 110, the requester terminal 130, and/or the provider terminal 140 may be implemented on the computing device 200. For example, the processing device 112 may be implemented on the computing device 200 and configured to perform functions of the processing device 112 disclosed in this disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing device 112 in accordance with techniques described herein. For example, the processor 210 may include interface circuits 210-1 and processing circuits 210-2 therein. The interface circuits 210-1 may be configured to receive electronic signals from a bus (not shown in FIG. 2), wherein the electronic signals encode structured data and/or instructions for the processing circuits 210-2 to process. The processing circuits 210-2 may conduct logic calculations, and then determine a conclusion, a result, and/or an instruction encoded as electronic signals. Then the interface circuits 210-1 may send out the electronic signals from the processing circuits 210-2 via the bus.

The computer instructions may include, for example, routines, programs, objects, components, data structures, procedures, modules, and functions, which perform particular functions described herein. For example, the processor 210 may determine one or more target POIs associated with a target address query. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the requester terminal 130, the provider terminal 140, the storage device 150, and/or any other component of the online to offline service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing device 112 for determining one or more target POIs.

The I/O 230 may input and/or output signals, data, information, etc. In some embodiments, the I/O 230 may enable a user interaction with the processing device 112. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing device 112 and the requester terminal 130, the provider terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G, etc.), or the like, or any combination thereof. In some embodiments, the communication port 240 may be and/or include a standardized communication port, such as RS232, RS485, etc.

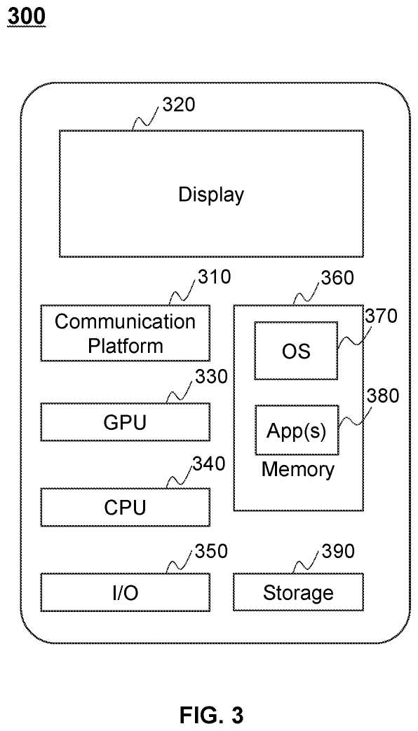

FIG. 3 is a schematic diagram illustrating exemplary hardware and/or software components of a mobile device 300 on which the requester terminal 130 or the provider terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an input/output (I/O) 350, a memory 360, and a storage 390. In some embodiments, any other suitable component, including but not limited to a system bus or a controller (not shown), may also be included in the mobile device 300.

In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to an online to offline service or other information from the online to offline service system 100, and sending information relating to an online to offline service or other information to the online to offline service system 100. User interactions with the information stream may be achieved via the I/O 350 and provided to the processing device 112 and/or other components of the online to offline service system 100 via the network 120.

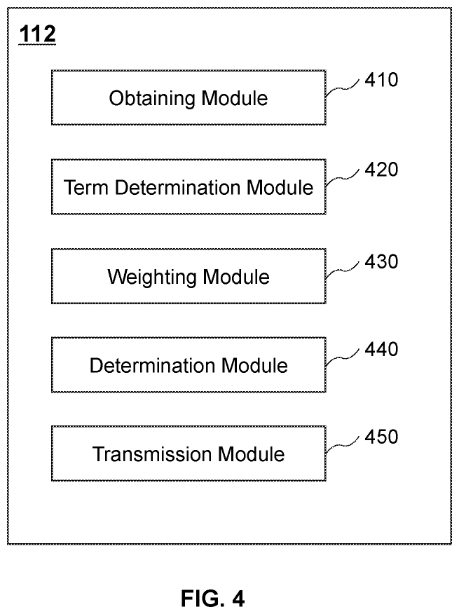

FIG. 4 is a block diagram illustrating an exemplary processing device 112 according to some embodiments of the present disclosure. As illustrated in FIG. 4, the processing device 112 may include an obtaining module 410, a term determination module 420, a weighting module 430, a determination module 440, and a transmission module 450.

The obtaining module 410 may be configured to obtain a target address query associated with a service request from a user terminal. The user terminal may be the requester terminal 130. For example, the obtaining module 410 may obtain the target address query associated with the service request from the requester terminal 130 via, for example, the network 120. The target address query may refer to a name of an intended location (e.g., a start location, a destination) associated with the service request (e.g., a request for taxi hailing services). Before sending out the service request to the server 110 (or the processing device 112), a service requester (e.g., a user of the requester terminal 130) may firstly input the target address query via the requester terminal 130. The obtaining module 410 may then obtain the target address query from the requester terminal 130 via, for example, the network 120. In some embodiments, the service requester may input the target address query on an interface in an input field in an application (e.g., a taxi-hailing application, the application 380 in FIG. 3) installed on the requester terminal 130. The target address query may be a text query, a voice query, etc. For example, the service requester may input the target address query by typing the target address query in the input filed of the application. As another example, the service requester may input the target address query via a voice input interface of the application.

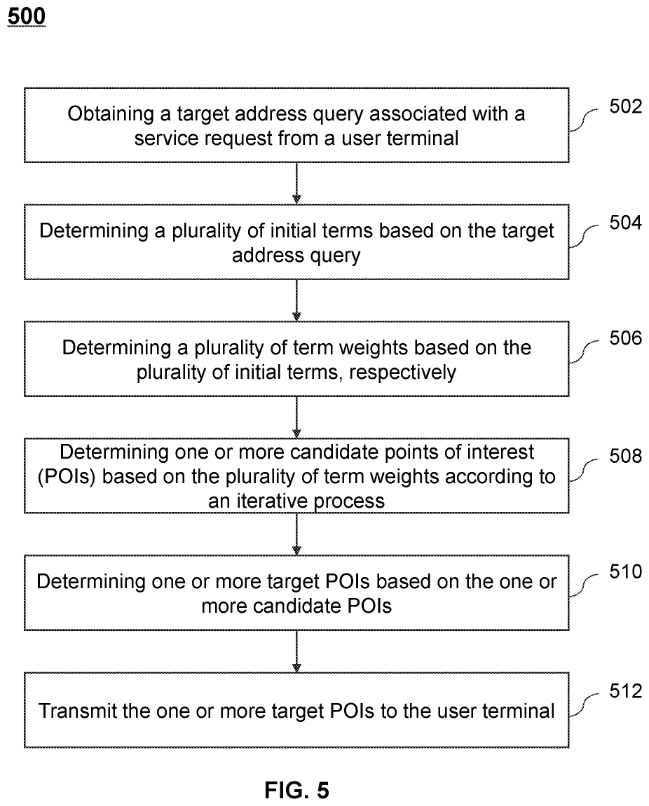

The term determination module 420 may be configured to determine a plurality of initial terms based on the target address query. In some embodiments, the target address query may include the plurality of initial terms. The term determination module 420 may segment the target address query into the plurality of initial terms. In some embodiments, the term determination module 420 may firstly analyze the target address query and determine whether the target address query is misspelled, i.e., determine whether there is at least one wrong term in the target address query. As used herein, a wrong term may refer to a term that is misspelled. If the target address query is misspelled, the term determination module 420 may process the target address query by correcting the spelling. In some embodiments, the term determination module 420 may rewrite and/or correct the target address query based on a noise channel model, a Bayes classifier, a maximum entropy model, or the like, or any combination thereof. The term determination module 420 may then segment the corrected target address query into the plurality of initial terms. Detailed descriptions of the determination of the plurality of initial terms may be found elsewhere in the present disclosure (e.g., FIG. 5 and the descriptions thereof).

The weighting module 430 may be configured to determine a plurality of term weights based on the plurality of initial terms, respectively. Each of the plurality of initial terms may correspond to one of the plurality of term weights. A term weight corresponding to an initial term may refer to a weight of the initial term in the target address query. In some embodiments, the weighting module 430 may determine a term weight for each of the plurality of initial terms by searching a pre-generated term table. In some embodiments, the pre-generated table may be stored in a storage module (not shown) of the processing device 112, the storage device 150, an external storage device, etc. The pre-generated term table may include a plurality of candidate terms and a plurality of corresponding candidate term weights. The weighting module 430 may find each of the plurality of initial terms among the plurality of candidate terms, and accordingly determine the term weight for the initial term in the pre-generated term table.

The determination module 440 may be configured to determine one or more candidate POIs based on the plurality of term weights according to an iterative process. The determination module 440 may determine the one or more candidate POIs based on the plurality of term weights and the plurality of initial terms according to the iterative process. Detailed descriptions of the determination of the one or more candidate POIs may be found elsewhere in the present disclosure (e.g., FIG. 5 and the descriptions thereof). The determination module 440 may also determine one or more target POIs based on the one or more candidate POIs. In some embodiments, the determination module 440 may determine the one or more candidate POIs as the one or more target POIs.

The transmission module 450 may be configured to transmit the one or more target POIs to the user terminal. For example, the transmission module 450 may transmit the one or more target POIs to the requester terminal 130 via the network 120. The requester terminal 130 may display the one or more target POIs via a user interface (not shown) the requester terminal 130. In some embodiments, the one or more target POIs may be displayed as a list that is close to an input field for the target address query. The service requester may further select a POI from the one or more target POIs as a service location (e.g., a start location, a destination) associated with the service request via the user interface.

The modules in the processing device 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined into a single module, and any one of the modules may be divided into two or more units. For example, the obtaining module 410 and the transmission module 450 may be combined as a single module which may both obtain a target address query associated with a service request from the requester terminal 130 and transmit one or more target POIs to the requester terminal 130. As another example, the processing device 112 may include a storage module (not shown) which may be used to store data generated by the above-mentioned modules.

FIG. 5 is a flowchart illustrating an exemplary process for determining one or more target POIs associated with a target address query according to some embodiments of the present disclosure. The process 500 may be implemented in the online to offline service system 100 illustrated in FIG. 1. For example, the process 500 may be stored in the storage device 150 and/or the storage 220 as a form of instructions (e.g., an application), and invoked and/or executed by the server 110 (e.g., the processing device 112 of the server 110, the processor 220 illustrated in FIG. 2, or one or more modules in the processing device 112 illustrated in FIG. 4). The operations of the illustrated process presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 502, the processing device 112 (e.g., the obtaining module 410) (e.g., the interface circuits 210-1) may obtain a target address query associated with a service request from a user terminal. The user terminal may be the requester terminal 130. For example, the processing device 112 may obtain the target address query associated with the service request from the requester terminal 130 via, for example, the network 120. The target address query may refer to a name of an intended location (e.g., a start location, a destination) associated with the service request (e.g., a request for taxi hailing services). Before sending out the service request to the server 110 (or the processing device 112), a service requester (e.g., a user of the requester terminal 130) may firstly input the target address query via the requester terminal 130. The processing device 112 may then obtain the target address query from the requester terminal 130 via, for example, the network 120. In some embodiments, the service requester may input the target address query on an interface in an input field in an application (e.g., a taxi-hailing application, the application 380 in FIG. 3) installed on the requester terminal 130. The target address query may be a text query, a voice query, etc. For example, the service requester may input the target address query by typing the target address query in the input filed of the application. As another example, the service requester may input the target address query via a voice input interface of the application.

In 504, the processing device 112 (e.g., the term determination module 420) (e.g., the processing circuits 210-2) may determine a plurality of initial terms based on the target address query. In some embodiments, the target address query may include the plurality of initial terms. The processing device 112 may segment the target address query into the plurality of initial terms. For example, the target address query may be “ShanHaiTian tourism development zone experimental primary school.” Merely by way of example, “ShanHaiTian tourism development zone experimental primary school” may be segmented into six initial terms: “ShanHaiTian,” “tourism,” “development,” “zone,” “experimental,” and “primary school.” In some embodiments, the processing device 112 may firstly analyze the target address query and determine whether the target address query is misspelled, i.e., determine whether there is at least one wrong term in the target address query. As used herein, a wrong term may refer to a term that is misspelled. If the target address query is misspelled, the processing device 112 may process the target address query by correcting the spelling. In some embodiments, the processing device 112 may rewrite and/or correct the target address query based on a noise channel model, a Bayes classifier, a maximum entropy model, or the like, or any combination thereof. The processing device 112 may then segment the corrected target address query into the plurality of initial terms. In some embodiments, the processing device 112 may segment the target address query/corrected target address query into the plurality of initial terms using a segmentation algorithm. Exemplary segmentation algorithm may include a segmentation algorithm based on dictionary (e.g., a forward maximum matching algorithm, a revise maximum matching algorithm, a bidirectional matching algorithm), a machine learning algorithm (e.g., a hidden Markov model (HMM), a support vector machine (SVM), a conditional random field (CRF) algorithm, a deep learning algorithm), etc.

In 506, the processing device 112 (e.g., the weighting module 430) (e.g., the processing circuits 210-2) may determine a plurality of term weights based on the plurality of initial terms, respectively. Each of the plurality of initial terms may correspond to one of the plurality of term weights. A term weight corresponding to an initial term may refer to a weight of the initial term in the target address query. Merely by way of example, the term weight corresponding to the initial term “tourism” in the target address query “ShanHaiTian tourism development zone experimental primary school” may be 0.4. In some embodiments, the processing device 112 may determine a term weight for each of the plurality of initial terms by searching a pre-generated term table. In some embodiments, the pre-generated table may be stored in a storage module (not shown) of the processing device 112, the storage device 150, an external storage device, etc. The pre-generated term table may include a plurality of candidate terms and a plurality of corresponding candidate term weights. The processing device 112 may find each of the plurality of initial terms among the plurality of candidate terms, and accordingly determine the term weight for the initial term in the pre-generated term table.

In some embodiments, the processing device 112 may determine the pre-generated table based on a plurality of historical service requests. In some embodiments, the processing device 112 may obtain the plurality of historical service requests from the storage device 150 via the network. In some embodiments, the processing device 112 may obtain the plurality of historical service requests from a storage module (not shown) in the processing device 112. The processing device 112 may obtain the plurality of historical service requests within a time period (e.g., the past one month, the past two months, the past three months). As used herein, the term “historical service request” may refer to a service request that has been completed. For example, a requester may send a service request for a service (e.g., a transportation service) to the online to offline service system 100. A service provider may accept the service request and provide the service to the requestor, indicating that the service request has been completed. The online to offline service system 100 may save this service request as a historical service order into a storage device (e.g., the storage device 150). In some embodiments, a historical service request may be saved in the storage device along with an identity of the requester (e.g., the telephone number corresponding to the requester). In some embodiments, each of the plurality of historical service requests may include a historical address query from a requester, one or more historical POIs (provided by the online to offline service system 10) associated with the historical address query, a historical POI selected by the requester from the one or more historical POIs as a service location (e.g., a historical start location, a historical destination) of the historical service request, etc. The processing device 112 may determine the plurality of candidate terms of the pre-generated table based on the plurality of historical service requests. For example, the processing device 112 may determine the plurality of candidate terms based on the historical POIs selected by requester(s) in the plurality of historical service requests. In some embodiments, the processing device 112 may determine the plurality of candidate term weights for the plurality of candidate terms using a term frequency-inverse document frequency (TF-IDF) algorithm. One or more parameters of the TF-IDF algorithm may be associated with the plurality of the historical service requests. In some embodiments, for each of the plurality of candidate terms of the pre-generated table, the processing device 112 may determine the corresponding candidate term weight based on the number of times the candidate term appeared in the historical POIs selected by requester(s). The more the candidate term has been selected, the larger the corresponding candidate term weight may be. In some embodiments, the online to offline system 100 may update the pre-generated table. For example, the online to offline system 100 may update the pre-generated table at regular interval (e.g., every three months).

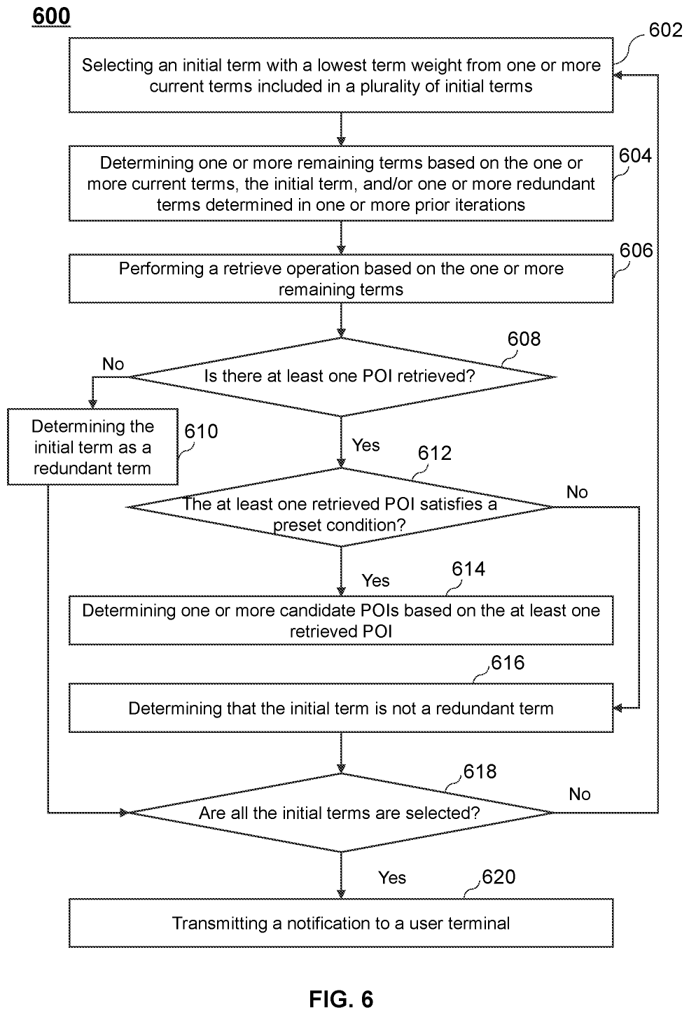

In 508, the processing device 112 (e.g., the determination module 440) (e.g., the processing circuits 210-2) may determine one or more candidate POIs based on the plurality of term weights according to an iterative process. The processing device 112 may determine the one or more candidate POIs based on the plurality of term weights and the plurality of initial terms according to the iterative process. In some embodiments, the iterative process may include one or more iterations. The iterative process may be terminated when one or more POIs retrieved in an iteration of the one or more iterations satisfy a preset condition. In some embodiments, the processing device 112 may determine one or more correlation values between the one or more POIs and the target address query using an identification model. A correlation value may indicate a similarity between a POI and the target address query. The larger the correlation value is, the higher the similarity between the POI and the target address query may be. The preset condition may include that the one or more correlation values corresponding to the one or more POIs retrieved are not less than a threshold. The threshold may be one of the default settings of the online to offline service system 100, or may be adjustable under different situations. In some embodiments, the correlation value and the threshold may be represented in various ways, such as an absolute value, a probability value, and a relative value, etc. For example, the correlation value may be a probability value and the threshold may be a probability threshold. Merely by way of example, the probability threshold may be 0.7, 0.75, 0.8, 0.85, and 0.9, etc. The identification model may include a gradient boosting decision tree (GBDT) model, a binary classification tree model, a regression model (e.g., a linear regression model), etc. The processing device 112 may further determine the one or more candidate POIs based on the one or more retrieved POIs that satisfy the preset condition. Detailed descriptions of the iterative process and the determination of the candidate POIs will be found in FIG. 6 and the descriptions thereof.

In 510, the processing device 112 (e.g., the determination module 440) (e.g., the processing circuits 210-2) may determine one or more target POIs based on the one or more candidate POIs. In some embodiments, the determination module 440 may determine the one or more candidate POIs as the one or more target POIs.

In 512, the processing device 112 (e.g., the transmission module 450) (e.g., the interface circuits 210-1) may transmit the one or more target POIs to the user terminal. For example, the processing device 112 may transmit the one or more target POIs to the requester terminal 130 via the network 120. The requester terminal 130 may display the one or more target POIs via a user interface (not shown) the requester terminal 130. In some embodiments, the one or more target POIs may be displayed as a list that is close to an input field for the target address query. The service requester may further select a POI from the one or more target POIs as a service location (e.g., a start location, a destination) associated with the service request via the user interface.

For illustration purposes, the present disclosure takes a target address query associated with an online transportation service as an example, it should be noted that the processing device 112 may process other queries associated with other online services (e.g., a map (e.g., GOOGLE Map, BAIDU Map, TENCENT Map)) navigation service, an online shopping service) according to the process and/or method disclosed elsewhere in the present disclosure. Take the online shopping service as an example, the processing device 112 may obtain a search query associated with an online shopping service request, wherein the search query may be associated with goods (e.g., clothes, shoes). The processing device 112 may determine a plurality of candidate search results associated with the search query and select one or more target search results from the plurality of candidate search results.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional steps (e.g., a storing step) may be added elsewhere in the process 500. In the storing step, the processing device 112 may store information (e.g., the target address query, the target POI(s)) associated with the service request in a storage device (e.g., the storage device 150).

FIG. 6 is a flowchart illustrating an exemplary process 600 for processing a target address query according to some embodiments of the present disclosure. The process 600 may be implemented in the online to offline service system 100 illustrated in FIG. 1. For example, the process 600 may be stored in the storage device 150 and/or the storage 220 as a form of instructions (e.g., an application), and invoked and/or executed by the server 110 (e.g., the processing device 112 of the server 110, the processor 220 illustrated in FIG. 2, or one or more modules in the processing device 112 illustrated in FIG. 4). The operations of the illustrated process presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting.

As illustrated in FIG. 6, the process 600 may correspond to an iterative process that includes one or more iterations. In some embodiments, the determination of the one or more candidate POIs as illustrated in the operation 508 of FIG. 5 may be implemented by performing one or more operations of the process 600. For example, the one or more candidate POIs may be determined according to the iterative process of the process 600.

In 602, the processing device 112 (e.g., the determination module 440) (e.g., the processing circuits 210-2) may select an initial term with a lowest term weight from one or more current terms included in a plurality of initial terms. In some embodiments, the plurality of initial terms may correspond to a target address query associated with a service request. The target address query or the corrected target address query may include the plurality of initial terms. More descriptions of the target address query and the corresponding plurality of initial terms may be found elsewhere in the present disclosure (e.g., FIG. 5 and the descriptions thereof). The one or more current terms may correspond to each of the one or more iterations. In the first iteration, the one or more current terms are the plurality of initial terms. In other iterations, the one or more current terms are the result of omitting one or more initial terms selected in one or more prior iterations from the plurality of initial terms. For example, in the second iteration (if any), the one or more current terms are the result of omitting the initial term selected in the first iteration from the plurality of initial terms. In the third iteration (if any), the one or more current terms are the result of omitting the initial term selected in the first iteration and the initial term selected in the second iteration from the plurality of initial terms, and so on. In each of the one or more iterations, the processing device 112 may select an initial term from one or more current terms included in the plurality of initial terms. In each iteration, the initial term selected may correspond to the lowest term weight among the one or more current terms. For example, the plurality of initial terms corresponding to the target address query may be six initial terms: “primary school,” “zone,” “development,” “experimental,” “tourism,” and “ShanHaiTian,” which are arranged in ascending order according to their term weights. Therefore, in the first iteration, the one or more current terms are the six initial terms (i.e., “primary school,” “zone,” “development,” “experimental,” “tourism,” and “ShanHaiTian.”), and the initial term “primary school” with the lowest term weight among the six initial terms may be selected. In the second iteration (if any), the one or more current terms are the five initial terms (i.e., “zone,” “development,” “experimental,” “tourism,” and “ShanHaiTian.”), and the initial term “zone” with the lowest term weight among the five initial terms may be selected.

In 604, the processing device 112 (e.g., the determination module 440) (e.g., the processing circuits 210-2) may determine one or more remaining terms based on the one or more current terms, the initial term, and/or one or more redundant terms determined in one or more prior iterations. As used herein, a redundant term may refer to a term that is redundant in the plurality of initial terms associated with the target address query. The redundant term may be caused by error/redundant input from the user of the requester terminal 130. The presence of a redundant term in the plurality of initial terms may cause a bad result (e.g., there is no POI retrieved or the retrieved POI(s) does not satisfy the preset condition). Detailed descriptions of the determination of a redundant term will be found in the following operations.

The one or more remaining terms and the one or more current terms may correspond to each of the one or more iteration. In some embodiments, in a current iteration, if all the initial terms selected in one or more prior iterations are determined as redundant terms, the processing device 112 may determine the one or more remaining terms of the current iteration by omitting, from the one or more current terms, the initial term selected in the iteration. For example, in the first iteration, the processing device 112 may determine the one or more remaining terms by omitting, from the one or more current terms (i.e., the plurality of initial terms in the first iteration), the initial term selected with the lowest term weight among the one or more current terms. If the initial term selected in the first iteration is determined as a redundant term, in the second iteration, the processing device 112 may determine the one or more remaining terms by omitting, from the one or more current terms (i.e., the result of omitting the initial term selected in the first iteration from the plurality of initial terms in the second iteration), the initial term selected in the second iteration. Merely by way of example, in the first iteration, the processing device 112 may omit the initial term “primary school” from the six current terms: “primary school,” “zone,” “development,” “experimental,” “tourism,” and “ShanHaiTian.” Therefore, five remaining terms “zone,” “development,” “experimental,” “tourism,” and “ShanHaiTian” are determined as the one or more remaining terms in the first iteration. Further, if the initial term “primary school” is determined as a redundant term, in the second iteration, the processing device 112 may omit the initial term “zone” from the five current terms: “zone,” “development,” “experimental,” “tourism,” and “ShanHaiTian.” Therefore, four remaining terms “development,” “experimental,” “tourism,” and “ShanHaiTian” are determined as the one or more remaining terms in the second iteration.

In some embodiments, in a current iteration, if one or more initial terms selected in one or more prior iterations are not determined as redundant terms, the processing device 112 may omit the initial term selected in the current iteration from the one or more current terms of the current iteration. The processing device 112 may combine the result of omitting the initial term selected in the current iteration from the one or more current terms of the current iteration and the one or more initial terms that are not redundant terms in the one or more prior iteration. The result of the combination may be determined as the one or more remaining terms of the current iteration. For example, the plurality of initial terms corresponding to the target address query may be six initial terms: “primary school,” “zone,” “development,” “experimental,” “tourism,” and “ShanHaiTian,” which are arranged in ascending order according to their term weights. Assuming that the initial term “primary school” is not determined as a redundant term in the first iteration and the initial term “zone” is determined as a redundant term in the second iteration. In the third iteration, the processing device 112 may omit the initial term “development” selected from the four current terms of the third iteration, i.e., the three initial terms “experimental,” “tourism,” and “ShanHaiTian” are reminded. The processing device 112 may then determine the one or more remaining terms for the third iteration by combining the initial term “zone” and the three initial terms “experimental,” “tourism,” and “ShanHaiTian”.

In 606, the processing device 112 (e.g., the determination module 440) (e.g., the processing circuits 210-2) may perform a retrieve operation based on the one or more remaining terms. In each of the one or more iterations, the processing device 112 may perform a retrieve operation based on the one or more remaining terms determined in the iteration. In some embodiments, the processing device 112 may perform the retrieve operation by searching a database using the one or more remaining terms. The database (e.g., the storage device 150) may include a plurality of POIs. Merely by way of example, in an iteration (e.g., the first iteration), the one or more remaining terms may be five initial terms: “ShanHaiTian,” “tourism,” “development,” “zone,” and “experimental.” The processing device 112 may search the database using the five initial terms.

In 608, the processing device 112 (e.g., the determination module 440) (e.g., the processing circuits 210-2) may determine whether there is at least one POI retrieved based on the retrieve operation.

In each iteration, the processing 112 may determine whether there is at least one POI retrieved based on the retrieve operation. In response to a determination that there is no POI retrieved, the processing device 112 may determine the initial term selected in the iteration as a redundant term in 610. The process 600 may then proceed to 618. On the other hand, in response to a determination that there is at least one POI retrieved, the processing device 112 may further determine whether the at least one retrieved POI satisfies a preset condition in 612. As described in connection with the operation 508 in FIG. 5, the preset condition may include that the at least one correlation value corresponding to the at least one retrieved POI is not less than the threshold (e.g., a probability threshold such as 0.7, 0.75, 0.8, 0.85, 0.9, etc.). More descriptions of the preset condition, the correlation value, and/or the threshold may be found elsewhere in the present disclosure (e.g., FIG. 5 and the descriptions thereof).

In response to a determination that the at least one retrieved POI satisfies the preset condition, the processing device 112 may determine one or more candidate POIs based on the at least one retrieved POI in 614. In some embodiments, the processing device 112 may determine the at least one retrieved POI as the one or more candidate POIs. In some embodiments, the processing device 112 may randomly select one or more POIs from the at least one retrieved POI. The one or more selected POIs may be determined as the one or more candidate POIs.

In some embodiments, the processing device 112 may rank the at least one retrieved POI from large to small or from small to large based on the correlation value of the at least one retrieved POI. For example, the larger the correlation value is, the higher the ranking of a corresponding POI may be. For example, the processing device 112 may rank (e.g., from large to small) the at least one retrieved POI based on the corresponding correlation value. The processing device 112 may further determine the top-ranked POIs (e.g., top 1, top 5, top 10, etc.) as the one or more candidate POIs.

In some embodiments, the processing device 112 may rank the at least one retrieved POI to produce a ranking result based on personalized information associated with the requester. For example, the larger a frequency that one of the at least one retrieved POI was selected by the requester as historical service locations (e.g., a historical start location, a historical destination) in historical service requests within a predetermined period (e.g., the past three months), the higher the ranking of the POI may be. The processing device 112 may rank (e.g., from large to small) the at least one retrieved POI based on the corresponding frequency. The processing device 112 may further determine the top-ranked POIs (e.g., top 1, top 5, top 10, etc.) as the one or more candidate POIs.

In some embodiments, after determining the one or more candidate POIs in the operation 614, the processing device 112 may determine the one or more candidate POIs as one or more target POIs and transmit the one or more target POIs to the user terminal.

In response to a determination that the at least one retrieved POI does not satisfy the preset condition, the processing device 112 may determine that the initial term selected in the iteration is not a redundant term in 616. The processing device 112 may then determine that the initial term selected in the iteration cannot be omitted. The process 600 may then proceed to 618.

In 618, the processing device 112 (e.g., the determination module 440) (e.g., the processing circuits 210-2) may determine whether all the initial terms corresponding to the target address query have been selected. If not all the initial terms are selected, the process 600 may proceed to a next iteration. Specifically, the process 600 may return back to the operation 602 to select a new initial term from the one or more current terms of the next iteration, and repeat operations 604 through 614. If all the initial terms have been selected, the iterative process associated with the target address query may be terminated. The processing device 112 may determine that there is no POI retrieved for the target address query. The process 600 may proceed to 620.

In 620, the processing device 112 (e.g., the determination module 440) (e.g., the processing circuits 210-2) may transmit a notification to the user terminal. For example, the transmission module 450 may transmit the notification to the requester terminal 130. In some embodiments, the notification may inform the requester (i.e., the user of the requester terminal 130) that there is no POI retrieved corresponding to the target address query inputted by the user and a new target address query may be needed. The notification may be in form of text, voice, and image, etc. If the new target address query is entered through the user terminal, the processing device 112 may repeat the process 600 (and/or the process 500) based on the new target address query.

Taking a target address query “ShanHaiTian tourism development zone experimental primary school” and a target POI “ShanHaiTian tourism holiday zone experimental primary school” as an example, the corresponding plurality of initial terms may be six initial terms: “primary school,” “zone,” “development,” “experimental,” “tourism,” and “ShanHaiTian,” which are arranged in ascending order according to their term weights. In the first iteration, the one or more current terms are the six initial terms and the initial term “primary school” is selected and omitted. The one or more remaining terms of the first iteration are the five initial terms: “zone,” “development,” “experimental,” “tourism,” and “ShanHaiTian.” The processing device 112 may perform the retrieve operation based on the five initial terms. If there is at least one POI retrieved, however the at least one retrieved POI does not satisfy the preset condition (i.e., the correlation value of the at least one retrieved POI is less than the threshold). For example, there is a POI including terms “experimental middle school” in the at least one retrieved POI. Accordingly, the processing device 112 may determine that the initial term “school” is not a redundant term, which cannot be omitted. In second iteration, the one or more current terms are the five initial terms: “zone,” “development,” “experimental,” “tourism,” and “ShanHaiTian.” The initial term “zone” is selected and omitted. The one or more remaining terms of the second iteration are the four initial terms “development,” “experimental,” “tourism,” “ShanHaiTian,” and the initial term “school” that is not determined as a redundant in the first iteration. The processing device 112 may perform the retrieve operation based on the four initial terms “development,” “experimental,” “tourism,” “ShanHaiTian,” and the initial term “school.” If there is no POI retrieved, the processing device 112 may determine that the initial term “zone” is a redundant term and there is other redundant term(s) in the four initial terms: “development,” “experimental,” “tourism,” and “ShanHaiTian.” In the third iteration, the one or more current terms are the four initial terms: “development,” “experimental,” “tourism,” and “ShanHaiTian.” The initial term “development” is selected and omitted. The one or more remaining terms of the third iteration are “primary school,” “experimental,” “tourism,” and “ShanHaiTian.” The processing device 112 may perform the retrieve operation based on the initial terms “primary school,” “experimental,” “tourism,” and “ShanHaiTian.” If there is at least one POI retrieved and the at least one retrieved POI satisfies the preset condition, the iterative process is terminated. The processing device 112 may determine one or more candidate POIs based on the at least one retrieved POI. The processing device 112 may transmit the one or more candidate POIs to the user terminal.

In some embodiments, one or more operations of the process 600 may be described as a finite-state machine (FSM). The FSM may include four elements: a current state, an event, an action, and a next state. For example, in an iteration, the retrieval of at least one POI based on an initial term selected may belong to the current state. The determining of whether the at least one retrieved POI satisfies the preset condition may belong to the event. If the at least one retrieved POI satisfies the preset condition, the terminating of the iterative process may belong to the action, and the determining of one or more candidate POIs based on the at least one retrieved POI may belong to the next state. If the at least one retrieved POI does not satisfy the preset condition, the determining of the initial term being not a redundant term and not all the initial terms having been selected may belong to the action, and the retrieving of at least one POI based on a new initial term selected in a next iteration may belong to the next state. For example, the plurality of initial terms may be six terms: “ShanHaiTian,” “tourism,” “development,” “zone,” “experimental,” and “primary school.” In the first iteration of the iterative process, the initial term “school” with the lowest term weight may be omitted from the six terms. The retrieving operations based on omitting the initial term “school” may be in the current state. If there is no POI retrieved (belonging to the event) or if the at least one retrieved POI does not satisfy the preset condition (belonging to the event), the initial term “zone” with the second lowest term weight may be omitted from the six terms. The retrieving operations based on omitting the initial term “zone” may belong to the next state, as compared with the retrieving operations based on omitting the initial term “school”.

It should be noted that the above description is provided for the purpose of illustration, and is not intended to limit the scope of the present disclosure. For persons having ordinary skills in the art, multiple variations and modifications may be made under the teaching of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining points of interest, comprising:
at least one storage device including a set of executable instructions; and
at least one processor adapted to communicate with the at least one storage device, wherein when executing the set of executable instructions, the at least one processor is configured to cause the system to:
obtain a target address query associated with a service request from a user terminal;
determine a plurality of initial terms based on the target address query;
determine a plurality of term weights based on the plurality of initial terms, respectively;
determine one or more candidate points of interest (POIs) based on the plurality of term weights according to an iterative process, wherein:
the iterative process includes one or more iterations; and
the iterative process is terminated when one or more POIs retrieved in an iteration of the one or more iterations satisfy a preset condition;
determine one or more target POIs based on the one or more candidate POIs; and
transmit the one or more target POIs to the user terminal.

2. The system of claim 1, wherein the target address query is a text query or a voice query.

3. The system of claim 1, wherein to determine the plurality of initial terms based on the target address query, the at least one processor is configured to cause the system to:
determine whether there is at least one wrong term in the target address query;
in response to a determination that there is at least one wrong term in the target address query, correct the target address query; and
segment the corrected target address query into the plurality of initial terms.

4. The system of claim 1, wherein to determine the plurality of term weights based on the plurality of initial terms, respectively, the at least one processor is further configured to cause the system to:
determine a term weight of the plurality of term weights for each of the plurality of initial terms by searching a pre-generated term table, wherein the pre-generated term table includes a plurality of candidate terms and a plurality of corresponding candidate term weights.

5. The system of claim 4, wherein the pre-generated term table is determined based on a term frequency-inverse document frequency algorithm.

6. The system of claim 1, wherein to determine the one or more candidate POIs based on the plurality of term weights according to the iterative process, the at least one processor is further configured to cause the system to:
in each of the one or more iterations,
select an initial term with a lowest term weight from one or more current terms included in the plurality of initial terms;
determine one or more remaining terms based on the one or more current terms, the initial term, or one or more redundant terms determined in one or more prior iterations;
perform a retrieve operation based on the one or more remaining terms;
determine whether there is at least one POI retrieved;
in response to a determination that there is at least one POI retrieved, determine whether the at least one retrieved POI satisfies the preset condition; and
in response to a determination that the at least one retrieved POI satisfies the preset condition, determine the one or more candidate POIs based on the at least one retrieved POI.

7. The system of claim 6, wherein the at least one processor is further configured to cause the system to:
in response to a determination that there is no POI retrieved, determine the initial term as a redundant term.

8. The system of claim 6, wherein the at least one processor is further configured to cause the system to:
in response to a determination that the at least one retrieved POI dose not satisfy the preset condition, determine that the initial term is not a redundant term.

9. The system of claim 6, wherein the at least one processor is further configured to cause the system to:
determine whether all the initial terms are selected; and
in response to a determination that all the initial terms are selected, transmit a notification to the user terminal.

10. A method for determining points of interest implemented on a computing device having at least one processor, at least one storage device, and a communication platform connected to a network, the method comprising:
obtaining a target address query associated with a service request from a user terminal;
determining a plurality of initial terms based on the target address query;
determining a plurality of term weights based on the plurality of initial terms, respectively;
determining one or more candidate points of interest (POIs) based on the plurality of term weights according to an iterative process, wherein:
the iterative process includes one or more iterations; and
the iterative process is terminated when one or more POIs retrieved in an iteration of the one or more iterations satisfy a preset condition;
determining one or more target POIs based on the one or more candidate POIs; and
transmitting the one or more target POIs to the user terminal.

11. The method of claim 10, wherein the target address query is a text query or a voice query.

12. The method of claim 10, wherein the determining of the plurality of initial terms based on the target address query includes:
determining whether there is at least one wrong term in the target address query;
in response to a determination that there is at least one wrong term in the target address query, correcting the target address query; and
segmenting the corrected target address query into the plurality of initial terms.

13. The method of claim 10, wherein the determining of the plurality of term weights based on the plurality of initial terms, respectively includes:
determining a term weight of the plurality of term weights for each of the plurality of initial terms by searching a pre-generated term table, wherein the pre-generated term table includes a plurality of candidate terms and a plurality of corresponding candidate term weights.

14. The method of claim 13, wherein the pre-generated term table is determined based on a term frequency-inverse document frequency algorithm.

15. The method of claim 10, wherein the determining of the one or more candidate POIs based on the plurality of term weights according to the iterative process includes:
in each of the one or more iterations,
selecting an initial term with a lowest term weight from one or more current terms included in the plurality of initial terms;
determining one or more remaining terms based on the one or more current terms, the initial term, or one or more redundant terms determined in one or more prior iterations;
performing a retrieve operation based on the one or more remaining terms;
determining whether there is at least one POI retrieved;
in response to a determination that there is at least one POI retrieved, determining whether the at least one retrieved POI satisfies the preset condition; and
in response to a determination that the at least one retrieved POI satisfies the preset condition, determining the one or more candidate POIs based on the at least one retrieved POI.

16. The method of claim 15, wherein the method further includes:
in response to a determination that there is no POI retrieved, determining the initial term as a redundant term.

17. The method of claim 15, wherein the method further includes:
in response to a determination that the at least one retrieved POI dose not satisfy the preset condition, determining that the initial term is not a redundant term.

18. The method of claim 15, wherein the method further includes:
determining whether all the initial terms are selected; and
in response to a determination that all the initial terms are selected, transmitting a notification to the user terminal.

19. A non-transitory computer readable medium, comprising executable instructions for determining points of interest, wherein when executed by at least one processor of a computing device, the executable instructions directs the at least one processor to perform a method, the method comprising:
obtaining a target address query associated with a service request from a user terminal;
determining a plurality of initial terms based on the target address query;
determining a plurality of term weights based on the plurality of initial terms, respectively;
determining one or more candidate points of interest (POIs) based on the plurality of term weights according to an iterative process, wherein:
the iterative process includes one or more iterations; and
the iterative process is terminated when one or more POIs retrieved in an iteration of the one or more iterations satisfy a preset condition;
determining one or more target POIs based on the one or more candidate POIs; and
transmitting the one or more target POIs to the user terminal.

20-23. (canceled)

24. The non-transitory computer readable medium of claim 19, wherein the determining of the one or more candidate POIs based on the plurality of term weights according to the iterative process includes:
in each of the one or more iterations,
selecting an initial term with a lowest term weight from one or more current terms included in the plurality of initial terms;
determining one or more remaining terms based on the one or more current terms, the initial term, or one or more redundant terms determined in one or more prior iterations;
performing a retrieve operation based on the one or more remaining terms;
determining whether there is at least one POI retrieved;
in response to a determination that there is at least one POI retrieved, determining whether the at least one retrieved POI satisfies the preset condition; and
in response to a determination that the at least one retrieved POI satisfies the preset condition, determining the one or more candidate POIs based on the at least one retrieved POI.

25-27. (canceled)
